(19) United States
(12) Patent Application Publication
(10) Pub. No.: US 2015/0010711 A1
(43) Pub. Date: Jan. 8, 2015

(54) Coating Applications

(71) Applicant: Dow Corning Corporation, MIDLAND, MI (US)

(72) Inventors: Victoria Ann James, Cardiff (GB); Pierre Leger, Antoing (BE); Bertrand Louis Julien Lenoble, Silly (BE); Donald Taylor Liles, Midland, MI (US); Kimberly M. Quackenbush, Freeland, MI (US)

(21) Appl. No.: 14/372,337

(22) PCT Filed: Jan. 31, 2013
(86) PCT No.: PCT/EP2013/051969

§ 371 Date: Jul. 15, 2014

Related U.S. Application Data
(60) Provisional application No. 61/596,296, filed on Feb. 8, 2012.

(51) Int. Cl. C08K 5/5419; B05D 3/00; B05D 7/12; B05D 7/14; C08K 5/06; B05D 7/06

(52) U.S. Cl. CPC C08K 5/5419; C08K 5/06; B05D 7/06; B05D 7/12; B05D 7/148; B05D 7/14; B05D 3/007
USPC 427/386; 524/267; 427/385.5; 427/387; 427/389; 427/389.7; 427/388.2; 427/391

(57) ABSTRACT

A coating composition containing an emulsion is provided. The emulsion contains a silicone gum, a ethylene oxide/propylene oxide copolymer and water. The coating composition is different than an acrylic composition. It is for example polyurethane, epoxy, alkyd, polyurethane-acrylic, polyester, Si-polyester, styrene-acrylic, vinyl acetate, Si-acrylics, silicone, fluoro-polymer, vinyl polymer or blends of.

### BACKGROUND OF THE INVENTION

Silicone gums generally consist of linear chains of poly(dimethylsiloxane) that typically possess kinetic viscosities greater than one million cSt at 25° C. Silicone gum emulsions are important in the coatings industry as they function as slip and anti-mar additives for both aqueous and non-aqueous coatings. An important industrial application of silicone gum emulsions is as “band ply lubricants” used in the manufacture of tires.

Preparation of aqueous mechanical emulsions of silicone gum is difficult due to the handling of such highly viscous materials. These emulsions are typically prepared using a specialized surfactant based on a siloxane copolymer resin. U.S. Pat. No. 4,125,470 to Fenton and Keil describes representative emulsions of this type. A drawback to these types of emulsions is that they contain xylene and other undesirable substances that are present during the manufacture of the siloxane copolymer resin.

Silicone gum can be emulsified using specialized equipment such as a twin screw extruder (TSE). However, the costs for such equipment are relatively high, both from a capital and an operational standpoint.

Thus, there exists a need to identify processes to prepare mechanical emulsions of silicone gums that do not require specialized surfactants containing aromatic solvents, nor require expensive emulsification equipment and that can be used as coating additives for both water-based and oil-based coatings.

### BRIEF SUMMARY OF THE INVENTION

The present inventors have discovered that an emulsion composition which contains a silicone gum, a ethylene oxide/propylene oxide copolymer and water can be effective as additive for a coating composition with the proviso that the coating composition is different than an acrylic composition.

The present disclosure relates to a method of improving the coefficient of friction, the water resistance, repellency, anti-blocking, slip abrasion, scratch, burnish resistance, anti-squeak, touch, anti-fouling or anti-graffiti of a coating comprising; combining the emulsion composition with a coating composition to form a pre-coat mixture, applying a film of the pre-coat mixture to a surface, curing the film to form a coating.

### DETAILED DESCRIPTION OF THE INVENTION

Preferably, the coating composition comprises:

1 to 99 weight percent of a coating emulsion,

0.01 to 20 weight percent of the emulsion composition containing a silicone gum, a ethylene oxide/propylene oxide copolymer and water

0 to 90 weight percent of an optional organic solvent.

The ethylene oxide/propylene oxide copolymer plays the role of surfactant.

Preferably, the ethylene oxide/propylene oxide block copolymer is a poly(oxyethylene)-poly(oxypropylene)-poly(oxyethylene) tri-block copolymer having the formula;

HO(CH₂CH₂O)ₘ(CH₂CH(CH₃)O)ₙ(CH₂CH₂O)ₘH

where

m may vary from 50 to 400, and

n may vary from 20 to 100.

In another preferred embodiment, the ethylene oxide/propylene oxide block copolymer is a tetrafunctional poly(oxyethylene)-poly(oxypropylene) block copolymer having the average formula;

[HO(CH₂CH₂O)_{q}(CH₂CH(CH₃)O)ᵣ]₂NCH₂CH₂N[(CH₂CH(CH₃)O)ᵣ(CH₂CH₂O)_{q}H]₂

where

q may vary from 50 to 400, and

r may vary from 15 to 75.

Preferably, the coating composition comprises polyurethane, acrylics, epoxy, alkyd, polyurethane-acrylic, polyester, Si-polyester, styrene-acrylic, vinyl acetate, Si-acrylics, silicone, fluoropolymer, vinyl polymer or blends of.

Preferably, the coating composition is an ink formulation, over print varnish, wood coating, industrial, flame retardant, high temperature resistance, protective coating, automotive weather stripping, cookware, bakeware, architectural, coil, can, plastic coatings, auto OEM and refinish, aerospace, marine, glass coating, or leather coating formulation.

Properties/benefits that these silicone resin emulsions provide to the coating include water resistance/reppellency, anti-blocking, slip (low friction) abrasion, flexibility, scratch, temperature resistance, hot hardness, UV resistance, easy clean, burnish resistance, anti-squeak, touch modification, anti-fouling and anti-graffiti.

### Forming a Silicone Gum Emulsion

The silicone gum emulsion can be made as follows:

I) forming a dispersion of;
A) 100 parts of a silicone gum,
B) 5 to 100 parts of a ethylene oxide/propylene oxide block copolymer,

II) admixing a sufficient amount of water to the dispersion from step I) to form an emulsion,

III) optionally, further shear mixing the emulsion.

As used herein, “parts” refers to parts by weight.

### The Silicone Gum

Component A) is a silicone gum. “Silicone gum” as used herein refers to predominately linear organopolysiloxanes having sufficiently high molecular weight (Mw) to provide kinetic viscosities greater than 500 thousand cSt at 25° C. While any organopolysiloxane considered as a gum may be selected as component (A), typically the silicone gum is a diorganopolysiloxane gum with a molecular weight sufficient to impart a William's plasticity number of at least about 30 as determined by the American Society for Testing and Materials (ASTM) test method 926. The silicon-bonded organic groups of the diorganopolysiloxane may independently be selected from hydrocarbon or halogenated hydrocarbon groups. These may be specifically exemplified by alkyl groups having 1 to 20 carbon atoms, such as methyl, ethyl, propyl, butyl, pentyl and hexyl; cycloalkyl groups, such as cyclohexyl and cycloheptyl; aryl groups having 6 to 12 carbon atoms, such as phenyl, tolyl and xylyl; aralkyl groups having 7 to 20 carbon atoms, such as benzyl and phenylethyl; and halogenated alkyl groups having 1 to 20 carbon atoms, such as 3,3,3-trifluoropropyl and chloromethyl. Thus, diorganopolysiloxane can be a homopolymer, a copolymer or a terpolymer containing such organic groups. Examples include homopolymers comprising dimethylsiloxy units, homopolymers comprising 3,3,3-trifluoropropylmethylsiloxy units, copolymers comprising dimethylsiloxy units and phenylmethylsiloxy units, copolymers comprising dimethylsiloxy units and 3,3,3-trifluoropropylmethylsiloxy units, copolymers of dimethylsiloxy units and diphenylsiloxy units and interpolymers of dimethylsiloxy units, diphenylsiloxy units and phenylmethylsiloxy units, among others.

The silicon-bonded organic groups of the diorganopolysiloxane may also be selected from alkenyl groups having 1 to 20 carbon atoms, such as vinyl, allyl, butyl, pentyl, hexenyl, or dodecenyl. Examples include; dimethylvinylsiloxy-endblocked dimethylpolysiloxanes; dimethylvinylsiloxy-endblocked dimethylsiloxane-methylvinylsiloxane copolymers; dimethylvinylsiloxy-endblocked methylphenylpolysiloxanes; dimethylvinylsiloxy-endblocked methylphenylsiloxane-dimethylsiloxane-methylvinylsiloxane copolymers.

The silicon-bonded organic groups of the diorganopolysiloxane may also be selected from various organofunctional groups such as amino, amido, mercapto, or epoxy functional groups.

The molecular structure is also not critical and is exemplified by straight-chain and partially branched straight-chain structures, the linear systems being the most typical.

The silicone gum used as component A) may also be a combination or mixture of any of the aforementioned polydiorganosiloxanes.

In one embodiment, the silicone gum is a hydroxy terminated polydimethylsiloxane gum having a viscosity of at least 20 million cP at 25° C. at 0.01 Hz.

The silicone gum may be used in combination with other organopolysiloxanes. Organopolysiloxanes (also named silicones) are polymers containing siloxane units independently selected from (R₃SiO_{1/2}), (R₂SiO_{2/2}),(RSiO_{3/2}), or (SiO_{4/2}) siloxy units, where R may be any monovalent organic group. When R is a methyl group in the (R₃SiO_{1/2}), (R₂SiO_{2/2}), (RSiO_{3/2}), or (SiO_{4/2}) siloxy units of an organopolysiloxane, the siloxy units are commonly referred to as M, D, T, and Q units respectively. These siloxy units can be combined in various manners to form cyclic, linear, or branched structures. The chemical and physical properties of the resulting polymeric structures can vary. For example organopolysiloxanes can be volatile or low viscosity fluids, high viscosity fluids/gums, elastomers or rubbers, and resins depending on the number and type of siloxy units in the average polymeric formula. R may be any monovalent organic group, alternatively R is a hydrocarbon group containing 1 to 30 carbons, alternatively R is an alkyl group containing 1 to 30 carbon atoms, or alternatively R is methyl.

The amount of the additional organopolysiloxane combined with the silicone gum may vary. Typically, 0.1 parts to 1000 parts by weight, alternatively 0.1 to 100 parts by weight of the additional organopolysiloxane is added for every 100 parts of the silicone gum.

In one embodiment, the silicone gum is combined with an aminofunctional organopolysiloxane. The aminofunctional organopolysiloxanes may be characterized by having at least one of the R groups in the formula RₙSiO_{(4-n)/2} be an amino functional group. The amino functional group may be present on any siloxy unit having an R substituent, that is, they may be present on any (R₃SiO_{1/2}), (R₂SO_{2/2}), or (RSiO_{3/2}) unit, and is designated in the formulas herein as R^{N}. The amino-functional organic group R^{N} is illustrated by groups having the formula; —R³NHR⁴, —R³NR₂⁴, or —R³NHR³NHR⁴, wherein each R³ is independently a divalent hydrocarbon group having at least 2 carbon atoms, and R⁴ is hydrogen or an alkyl group. Each R³ is typically an alkylene group having from 2 to 20 carbon atoms. R³ is illustrated by groups such as; —CH₂CH₂—, —CH₂CH₂CH₂—, —CH₂CHCH₃—, —CH₂CH₂CH₂CH₂—, —CH₂CH(CH₃)CH₂—, —CH₂CH₂CH₂CH₂CH₂—, —CH₂CH₂CH₂CH₂CH₂CH₂—, —CH₂CH₂CH(CH₂CH₃)CH₂CH₂CH₂—, —CH₂CH₂CH₂CH₂CH₂CH₂CH₂CH₂—, and —CH₂CH₂CH₂CH₂CH₂CH₂CH₂CH₂CH₂CH₂—. The alkyl groups R⁴ are as illustrated above for R. When R⁴ is an alkyl group, it is typically methyl.

Some examples of suitable amino-functional hydrocarbon groups are;

—CH₂CH₂NH₂, —CH₂CH₂CH₂NH₂, —CH₂CH(CH₃)NH₂, —CH₂CH₂CH₂CH₂NH₂, —CH₂CH₂CH₂CH₂CH₂NH₂, —CH₂CH₂CH₂CH₂CH₂CH₂NH₂, —CH₂CH₂NHCH₃, —CH₂CH₂CH₂NHCH₃, —CH₂CH(CH₃)CH₂NHCH₃, —CH₂CH₂CH₂CH₂NHCH₃, —CH₂CH₂NHCH₂CH₂NH₂, —CH₂CH₂CH₂NHCH₂CH₂NH₂, —CH₂CH₂CH₂NHCH₂CH₂CH₂NH₂, —CH₂CH₂CH₂CH₂NHCH₂CH₂CH₂CH₂NH₂, —CH₂CH₂NHCH₂CH₂NHCH₃, —CH₂CH₂CH₂NHCH₂CH₂CH₂NHCH₃, —CH₂CH₂CH₂CH₂NHCH₂CH₂CH₂CH₂NHCH₃, and —CH₂CH₂NHCH₂CH₂NHCH₂CH₂CH₂CH₃.

Alternatively, the amino functional group is —CH₂CH(CH₃)CH₂NHCH₂CH₂NH₂

The aminofunctional organopolysiloxane used in combination with the silicone gum may be selected from those having the average formula;

[R₃SiO_{1/2}] [R₂SiO_{2/2}]ₐ[RR^{N}SiO_{2/2}]_{b}[R₃SiO_{1/2}]

where;

a is 1-1000, alternatively 1 to 500, alternatively 1 to 200,

b is 1-100, alternatively 1 to 50, alternatively 1 to 10,

R is independently a monovalent organic group,

alternatively R is a hydrocarbon containing 1-30 carbon atoms,

alternatively R is a monovalent alkyl group containing 1-12 carbons, or

alternatively R is a methyl group;

R^{N} is as defined above.

The aminofunctional organopolysiloxane used in combination with the silicone gum may also be a combination of any of the aforementioned aminofunctional organopolysiloxanes.

### B) The Ethylene Oxide/Propylene Oxide Block Copolymer

Component B) is an ethylene oxide/propylene oxide block copolymer. Component B) may be selected from those ethylene oxide/propylene oxide block copolymers known to have surfactant behaviour. Typically, the ethylene oxide/propylene oxide block copolymers useful as component B) are surfactants having an H LB of at least 12, alternatively, at least 15, or alternatively at least 18.

The molecular weight of the ethylene oxide/propylene oxide block copolymer may vary, but typically is at least 4,000 g/mol, alternatively at least 8,000 g/mol, or at least 12,000 g/mol.

The amounts of ethylene oxide (EO) and propylene oxide (PO) present in the ethylene oxide/propylene oxide block copolymer may vary, but typically, the amount of EO may vary from 50 percent to 80 percent, or alternatively from 60 percent to about 85 percent, or alternatively from 70 percent to 90 percent.

In one embodiment, component B) is a poly(oxyethylene)-poly(oxypropylene)-poly(oxyethylene) tri-block copolymer. Poly(oxyethylene)-poly(oxypropylene)-poly(oxyethylene) tri-block copolymers are also commonly known as Poloxamers. They are nonionic triblock copolymers composed of a central hydrophobic chain of polyoxypropylene (poly(propylene oxide)) flanked by two hydrophilic chains of polyoxyethylene (poly(ethylene oxide)).

Poly(oxyethylene)-poly(oxypropylene)-poly(oxyethylene) tri-block copolymers are commercially available from BASF (Florham Park, N.J.) and are sold under the tradename PLURONIC®. Representative, non-limiting examples suitable as component (B) include; PLURONIC® F127, PLURONIC® F98, PLURONIC® F88, PLURONIC®F89, PLURONIC® F87, PLURONIC® F77 and PLURONIC® F68, and PLURONIC® F-108.

In a further embodiment, the poly(oxyethylene)-poly(oxypropylene)-poly(oxyethylene) tri-block copolymer has the formula;

HO(CH₂CH₂O)ₘ(CH₂CH(CH₃)O)ₙ(CH₂CH₂O)ₘH

where;

the subscript “m” may vary from 50 to 400, or alternatively from 100 to 300, and

the subscript “n” may vary from 20 to 100, or alternatively from 25 to 100.

In one embodiment, component B) is a tetrafunctional poly(oxyethylene)-poly(oxypropylene) block copolymer derived from the sequential addition of propylene oxide and ethylene oxide to ethylene diamine. These tetra-functional block copolymers are also commonly known as Poloxamines. The tetrafunctional poly(oxyethylene)-poly(oxypropylene) block copolymer may have the average formula;

[HO(CH₂CH₂O)_{q}(CH₂CH(CH₃)O)ᵣ]₂NCH₂CH₂N[(CH₂CH(CH₃)O)ᵣ(CH₂CH₂O)_{q}H]₂

where;

the subscript “q” may vary from 50 to 400, or alternatively from 100 to 300, and

the subscript “r” may vary from 15 to 75, or alternatively from 20 to 50.

Tetrafunctional poly(oxyethylene)-poly(oxypropylene) block copolymers are commercially available from BASF (Florham Park, N.J.) and are sold under the tradename TETRONIC®. Representative, non-limiting examples suitable as component (B) include; TETRONIC® 908, TETRONIC® 1107, TETRONIC® 1307, TETRONIC® 1508 and TETRONIC® 1504.

The amount of components A) and B) combined in step I) are as follows;

100 parts of a silicone gum, and

5 to 100 parts, alternatively 10 to 40 parts, or alternatively 10 to 25 of the ethylene oxide/propylene oxide block copolymer.

In one embodiment, the dispersion formed in step I) consists essentially of components A) and B) as described above. In this embodiment, no additional surfactants or emulsifiers are added in step I). Furthermore, no solvents are added for the purpose of enhancing formation of an emulsion. As used herein, the phrase “essentially free of “solvents” means that solvents are not added to components A) and B) in order to create a mixture of suitable viscosity that can be processed on typical emulsification devices. More specifically, “solvents” as used herein is meant to include any water immiscible low molecular weight organic or silicone material added to the non-aqueous phase of an emulsion for the purpose of enhancing the formation of the emulsion, and is subsequently removed after the formation of the emulsion, such as evaporation during a drying or film formation step. Thus, the phrase “essentially free of solvent” is not meant to exclude the presence of solvent in minor quantities in process or emulsions of the present invention. For example, there may be instances where the components A) and B) may contain minor amounts of solvent as supplied commercially. Small amounts of solvent may also be present from residual cleaning operations in an industrial process. Preferably, the amount of solvent present in the premix should be less than 2% by weight of the mixture, and most preferably the amount of solvent should be less than 1% by weight of the mixture.

The dispersion of step (I) may be prepared by combining components A) and B) and further mixing the components to form a dispersion. The resulting dispersion may be considered as a homogenous mixture of the two components. The present inventors have unexpectedly found that certain ethylene oxide/propylene oxide block copolymers readily disperse with silicone gum compositions, and hence enhance the subsequent formation of emulsion compositions thereof. Mixing can be accomplished by any method known in the art to effect mixing of high viscosity materials. The mixing may occur either as a batch, semi-continuous, or continuous process. Mixing may occur, for example using, batch mixing equipments with medium/low shear include change-can mixers, double-planetary mixers, conical-screw mixers, ribbon blenders, double-arm or sigma-blade mixers; batch equipments with high-shear and high-speed dispersers include those made by Charles Ross & Sons (NY), Hockmeyer Equipment Corp. (NJ); batch mixing equipment such as those sold under the tradename Speedmixer®; batch equipments with high shear actions include Banbury-type (CW Brabender Instruments Inc., NJ) and Henschel type (Henschel mixers America, TX). Illustrative examples of continuous mixers/compounders include extruders single-screw, twin-screw, and multi-screw extruders, co-rotating extruders, such as those manufactured by Krupp Werner & Pfleiderer Corp (Ramsey, N.J.), and Leistritz (NJ); twin-screw counter-rotating extruders, two-stage extruders, twin-rotor continuous mixers, dynamic or static mixers or combinations of these equipments.

The process of combining and mixing components A) and B) may occur in a single step or multiple step process. Thus, components A) and B) may be combined in total, and subsequently mixed via any of the techniques described above. Alternatively, a portion(s) of components A) and B) may first be combined, mixed, and followed by combining additional quantities of either or both components and further mixing. One skilled in the art would be able to select optimal portions of components A) and B) for combing and mixing, depending on the selection of the quantity used and the specific mixing techniques utilized to perform step I) to provide a dispersion of components A) and B).

Step II of the process involves admixing sufficient water to the mixture of step I to form an emulsion. Typically 5 to 700 parts water are mixed for every 100 parts of the step I mixture to form an emulsion. In one embodiment the emulsion formed is a water continuous emulsion. Typically, the water continuous emulsion has dispersed particles of the silicone gum from step I, and having an average particle size less than 150 μm.

The amount of water added in step II) can vary from 5 to 700 parts per 100 parts by weight of the mixture from step I. The water is added to the mixture from step I at such a rate so as to form an emulsion of the mixture of step I. While this amount of water can vary depending on the selection of the amount of silicone gum present and the specific ethylene oxide/propylene oxide block copolymer used, generally the amount of water is from 5 to 700 parts per 100 parts by weight of the step I mixture, alternatively from 5 to 100 parts per 100 parts by weight of the step I mixture, or alternatively from 5 to 70 parts per 100 parts by weight of the step I mixture.

Typically the water is added to the mixture from step I in incremental portions, whereby each incremental portion comprises less than 30 weight % of the mixture from step I and each incremental portion of water is added successively to the previous after the dispersion of the previous incremental portion of water, wherein sufficient incremental portions of water are added to form an emulsion.

Alternatively, a portion or all the water used in step I) may be substituted with various hydrophilic solvents that are soluble with water such as low molecular weight alcohols, ethers, esters or glycols. Representative non-limiting examples include low molecular weight alcohols such as methanol, ethanol, propanol, isopropanol and the like; low molecular weight ethers such as di(propyleneglycol) mono methyl ether, di(ethyleneglycol) butyl ether, di(ethyleneglycol) methyl ether, di(propyleneglycol) butyl ether, di(propyleneglycol) methyl ether acetate, di(propyleneglycol) propyl ether, ethylene glycol phenyl ether, propylene glycol butyl ether, 1-methoxy-2-propanol, 1-methoxy-2-propyl acetate, propylene glycol propyl ether, 1-phenoxy-2-propanol, tri(propyleneglycol) methyl ether and tri(propyleneglycol) butyl ether, and other like glycols.

Mixing in step (II) can be accomplished by any method known in the art to affect mixing of high viscosity materials. The mixing may occur either as a batch, semi-continuous, or continuous process. Any of the mixing methods as described for step (I), may be used to affect mixing in step (II). Typically, the same equipment is used to effect mixing in steps I) and II).

Optionally, the water continuous emulsion formed in step (II) may be further sheared according to step (III) to reduce particle size and/or improve long term storage stability. The shearing may occur by any of the mixing techniques discussed above.

The emulsion products resulting from the present process may be an oil/water emulsion, a water/oil emulsion, a multiple phase or triple emulsion.

In one embodiment, the emulsion products produced by the present process are oil/water emulsions. The oil/water emulsion may be characterized by average volume particle of the dispersed silicone gum (oil) phase in a continuous aqueous phase. The particle size may be determined by laser diffraction of the emulsion. Suitable laser diffraction techniques are well known in the art. The particle size is obtained from a particle size distribution (PSD). The PSD can be determined on a volume, surface, length basis. The volume particle size is equal to the diameter of the sphere that has the same volume as a given particle. The term Dv represents the average volume particle size of the dispersed particles. Dv 50 is the particle size measured in volume corresponding to 50% of the cumulative particle population. In other words if Dv 50=10 μm, 50% of the particle have an average volume particle size below 10 μm and 50% of the particle have a volume average particle size above 10 μm. Dv 90 is the particle size measured in volume corresponding to 90% of the cumulative particle population.

The average volume particle size of the dispersed siloxane particles in the oil/water emulsions is between 0.1 μm and 150 μm; or between 0.1 μm and 30 μm; or between 0.3 μm and 5.0 μm.

Silicone gum content of the present emulsion may vary from 0.5 weight percent to 95 weight percent, alternatively from 20 weight percent to 80 weight percent, or alternatively from 40 weight percent to 60 weight percent.

Additional additives and components may also be included in the emulsion compositions, such as preservatives, freeze/thaw additives, and various thickeners.

The emulsions produced by the present process may be used as coatings additives for both water-based and oil-based coatings to improve slip, coefficient of friction, or anti-mar properties. The emulsions may also be used in the manufacture of tires as band ply lubricants. The emulsions may also be used in antifoam formulations as well as in release compositions.

In one embodiment, the present emulsions are used as an additive in coating compositions containing an acrylic emulsion. The present coating compositions comprise:
i) 1 to 99 weight percent of a coating emulsion;

alternatively 10 to 99 weight percent of a coating emulsion,

alternatively 50 to 99 weight percent of coating emulsion, or

alternatively 90 to 99 weight percent of coating emulsion,
ii) 0.01 to 20 weight percent of a silicone gum emulsion as described above;

alternatively .01 to 20 weight percent of the silicone gum emulsion,

alternatively 1 to 15 weight percent of the silicone gum emulsion, or

alternatively 1 to 10 weight percent of the silicone gum emulsion, and
iii) 0 to 90 weight percent of an organic solvent;

alternatively 1 to 90 weight percent of an organic solvent,

alternatively 1 to 50 weight percent of an organic solvent, or

alternatively 1 to 15 weight percent of an organic solvent.

The present coating compositions contain a coating composition for example a coating emulsion.

The present coating compositions optionally may also contain an organic solvent. The organic solvent may be selected from any organic solvents that are typically used to prepare coating compositions. The organic solvent may include a combination of two or more solvents. When used in the coating compositions, the organic solvent may be present in compositions up to a maximum of 90 weight percent of the composition.

In one embodiment, the organic solvent is a glycol solvent. The glycol solvent helps reduce viscosity and may aid wetting or film coalescence. Representative glycol solvents include ethylene glycol, ethylene glycol methyl ether, ethylene glycol ethyl ether, ethylene glycol monobutyl ether, ethylene glycol-2-ethylhexyl ether, propylene glycol, propylene glycol methyl ether, propylene glycol ethyl ether, propylene glycol monobutyl ether, propylene glycol-2-ethylhexyl ether, diethylene glycol, diethylene glycol methyl ether, diethylene glycol ethyl ether, diethylene glycol monobutyl ether, diethylene glycol-2-ethylhexyl ether, dipropylene glycol, dipropylene glycol methyl ether, dipropylene glycol ethyl ether, dipropylene glycol monobutyl ether, dipropylene glycol-2-ethylhexyl ether, and mixtures thereof hydrophilic glycol solvents (e.g., propylene glycol methyl ether or dipropylene glycol monomethyl ether) are preferred.

In one embodiment, the organic solvent is an alcohol. Representative alcohol solvents include both lower molecular weight alcohols; such as methanol, ethanol, propanol, and butanol; as well as branched hydrocarbyl based alcohols like Texanol® solvents; such as 2,2,4-Trimethyl-1,3-pentanediolmono(2-methylpropanoate).

In a further embodiment, the organic solvent is a combination of a glycol and alcohol, as described above.

The present coating compositions may be prepared by simply combining the components with mixing.

The present silicone gum emulsions may be incorporated into the coating compositions at various amounts by simply mixing the silicone gum emulsion into a pre-formed coating composition. The amount of the silicone gum emulsion may vary, but typically from 0.1 parts by weight of the silicone gum emulsion to 20 parts by weight are used, as based on the total coating composition. The resulting pre-coat mixture may then be applied as a film onto various substrates, and the film cured by any method known in the art. Typically, the films are cured by simply allowing the film to air dry, or alternatively by heating the film.

In one embodiment, the coating composition selected is an ink formulation. Any commercially available ink formulation may be selected.

### EXAMPLES

The following example is included to demonstrate certain embodiments of the invention. It should be appreciated by those of skill in the art that the techniques disclosed in the example which follow represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention. All percentages are in wt. %. All measurements were conducted at 23° C. unless indicated otherwise.

### Emulsification of Silicone Gum Using Pluronic® F-108

First, 15 g of silicone gum (Dow Corning®SGM-36, a hydroxy terminated polydimethylsiloxane) was weighed into a Max 40 cup along with 1.5 g of Pluronic® F-108 nonionic surfactant and 10 g of 3 mm glass beads. The cup was closed and placed inside a DAC-150 SpeedMixer® and the cup was spun at maximum speed (3450 RPM) for 2 minutes. The cup was opened and the mixture, now very warm, had become a creamy white paste that easily flowed when mixed with a spatula. The walls of the cup were scraped with a spatula and the cup was spun again at maximum speed for 1 minute. Then, 0.88 g of water was added to the cup and the cup was spun for 30 seconds at maximum speed. An additional 1.2 g of water was added and the cup was again spun for 30 seconds at maximum speed. Two more water additions were made, one of 2.5 g and the other 3.92 g with the cup being spun for 20 seconds after each water addition. The milky white mixture was now finished and it consisted of an o/w emulsion of silicone gum having a silicone content of 60 percent by weight. Particle size of the emulsion was determined using a Malvern Mastersizer S (version 2.19) and the results were: Dv50=6.93 um, Dv90=13.24 um.

### Example 1

A waterborne wood coating formulation containing an PUD polyurethane emulsion, representative of a parquet wood formulation, was prepared as follows:

| Component | Material Wt % |
|---|---|
| Dowanol DPnB | 4.83 |
| Deionized Water | 7.04 |
| NeoRez 2180 Resin | 88.13 |

Formulations with additives were prepared by adding 0.30 wt % of DC 52 Additive (a commercially available silicone gum emulsion from Dow Corning Corp., Midland, Mich.) or 0.30 wt % of the new silicone gum emulsion made with Pluronic surfactant (these contain the same % of the active ingredient SGM 36 in the formulations). Each formulation was coated on aluminium panels using a draw down bar at approximately 50 microns wet film thickness. The panels were allowed to dry for 24 hours and the dried panels were visually inspected and compared to each other. No differences between the panels made with the new silicone gum emulsion or DC 52 Additive were observed.

The dynamic coefficient of friction (CoF) was measured for each. The coating composition containing DC 52 additive had a CoF of 0.154, whereas the coating containing the representative silicone gum emulsion had a CoF of 0.127.

1. A coating composition containing an emulsion composition which emulsion composition contains a silicone gum, a ethylene oxide/propylene oxide copolymer and water with the proviso that the coating composition is different than an acrylic composition.

2. The coating composition of claim 1 wherein the coating composition comprises:
i) 1 to 99 weight percent of a coating emulsion,
ii) 0.01 to 20 weight percent of the emulsion composition containing a silicone gum, a ethylene oxide/propylene oxide copolymer and water
iii) 0 to 90 weight percent of an optional organic solvent

3. The coating composition of claim 1 wherein the ethylene oxide/propylene oxide block copolymer is a poly(oxyethylene)-poly(oxypropylene)-poly(oxyethylene) tri-block copolymer having the formula;
HO(CH2CH2O)m(CH2CH(CH3)O)n(CH2CH2O)mH
where;
m may vary from 50 to 400, and
n may vary from 20 to 100.

4. The coating composition of claim 1 wherein the ethylene oxide/propylene oxide block copolymer is a tetrafunctional poly(oxyethylene)-poly(oxypropylene) block copolymer having the average formula;
[HO(CH₂CH₂O)_{q}(CH₂CH(CH₃)O)ᵣ]₂NCH₂CH₂N[(CH₂CH(CH₃)O)ᵣ(CH₂CH₂O)_{q}H]₂
where
q may vary from 50 to 400, and
r may vary from 15 to 75.

5. A method of improving the coefficient of friction, the water resistance, repellency, anti-blocking, slip abrasion, scratch, burnish resistance, anti-squeak, touch, anti-fouling or anti-graffiti properties of a coating comprising; combining the emulsion of claim 1 with a coating composition to form a pre-coat mixture, applying a film of the pre-coat mixture to a surface, curing the film to form a coating.

6. The method of claim 5 wherein the coating composition comprises polyurethane, epoxy, alkyd, polyurethane-acrylic, polyester, Si-polyester, styrene-acrylic, vinyl acetate, Si-acrylics, silicone, fluoropolymer, vinyl polymer or blends of.

7. The method of claim 6 wherein the coating composition is an ink formulation, over print varnish, wood coating, industrial, flame retardant, high temperature resistance, protective coating, automotive weather stripping, cookware, bakeware, architectural, coil, can, plastic coatings, auto OEM and refinish, aerospace, marine, glass coating, or leather coating formulation.

8. A coating additive comprising a silicone gum, an ethylene oxide/propylene oxide block copolymer and water.

9. The coating composition of claim 2 wherein the ethylene oxide/propylene oxide block copolymer is a poly(oxyethylene)-poly(oxypropylene)-poly(oxyethylene) tri-block copolymer having the formula;
HO(CH2CH2O)m(CH2CH(CH3)O)n(CH2CH2O)mH
where;
m may vary from 50 to 400, and
n may vary from 20 to 100.

10. The coating composition of claim 2 wherein the ethylene oxide/propylene oxide block copolymer is a tetrafunctional poly(oxyethylene)-poly(oxypropylene) block copolymer having the average formula;
[HO(CH₂CH₂O)_{q}(CH₂CH(CH₃)O)ᵣ]₂NCH₂CH₂N[(CH₂CH(CH₃)O)ᵣ(CH₂CH₂O)_{q}H]₂
where
q may vary from 50 to 400, and
r may vary from 15 to 75.

11. The coating composition of claim 1 wherein the silicone gum has a kinetic viscosity greater than 500 thousand cSt at 25° C.

12. The coating composition of claim 2 wherein the silicone gum has a kinetic viscosity greater than 500 thousand cSt at 25° C.

13. The coating composition of claim 1 herein the silicone gum is a hydroxy terminated polydimethylsiloxane gum having a viscosity of at least 20 million cP at 25° C. at 0.01 Hz.

14. The coating composition of claim 2 herein the silicone gum is a hydroxy terminated polydimethylsiloxane gum having a viscosity of at least 20 million cP at 25° C. at 0.01 Hz.

15. The coating composition of claim 2 wherein the optional organic solvent is a glycol solvent, an alcohol solvent or a combination of a glycol solvent and an alcohol solvent.

16. The coating composition of claim 15 wherein the glycol solvent is ethylene glycol, ethylene glycol methyl ether, ethylene glycol ethyl ether, ethylene glycol monobutyl ether, ethylene glycol-2-ethylhexyl ether, propylene glycol, propylene glycol methyl ether, propylene glycol ethyl ether, propylene glycol monobutyl ether, propylene glycol-2-ethylhexyl ether, diethylene glycol, diethylene glycol methyl ether, diethylene glycol ethyl ether, diethylene glycol monobutyl ether, diethylene glycol-2-ethylhexyl ether, dipropylene glycol, dipropylene glycol methyl ether, dipropylene glycol ethyl ether, dipropylene glycol monobutyl ether, dipropylene glycol-2-ethylhexyl ether, or mixtures thereof.

17. The coating composition of claim 15 wherein the alcohol solvent is methanol, ethanol, propanol, butanol, or 2,2,4-trimethyl-1,3-pentanediolmono(2-methylpropanoate).
